(19) United States
(12) Patent Application Publication
(10) Pub. No.: US 2014/0126230 A1
(43) Pub. Date: May 8, 2014

(54) Portable Computer Carrying and Locking Device

(71) Applicant: Dean Harris, Red Deer (CA)

(72) Inventor: Dean Harris, Red Deer (CA)

(21) Appl. No.: 14/118,637

(22) PCT Filed: May 16, 2012
(86) PCT No.: PCT/CA2012/000471

§ 371 Date: Jan. 20, 2014

Related U.S. Application Data
(60) Provisional application No. 61/487,975, filed on May 19, 2011.

(51) Int. Cl. A45C 13/18; E05B 73/00; H02J 7/35; A45C 13/30; G06F 1/16; F21V 21/00

(52) U.S. Cl. CPC A45C 13/18; G06F 1/1613; F21V 21/00; H02J 7/35; A45C 13/30; E05B 73/0011
USPC 362/382; 361/679.26; 320/101; 70/58

(57) ABSTRACT

Disclosed is a portable computer carrying and securement device, comprising an elastic covering adapted to surround the outer structure of a closed laptop computer or tablet, wherein the covering includes an internal cable attaching to a rotating spool for tightening the cable and covering around the laptop for security purposes. Attached to the upper portion of the covering is a ratcheting and carrying handle, which attaches to the spool for winding the cable therearound and for applying compression onto the outer portion of the computer to prevent tampering or unauthorized access. The handle is further capable of releasing the spool and thus the tension on the cable via a directed outward release motion. This motion is prevented by a locking mechanism and combination privy to only authorized users. The device further incorporates accessories that facilitate recharging of the laptop, locking the assembly to an external structure and an outward-facing display.

### CROSS REFERENCE TO RELATED APPLICATION

This application claims the benefit of U.S. Provisional Application No. 61/487,975 filed on May 19, 2011, entitled “Lap Lock.”

### BACKGROUND OF THE INVENTION

1. Field of the Invention

The present invention relates to portable computers and physical security devices therefor that prevent unauthorized access and theft thereof. More specifically, the present invention relates to a laptop or tablet computer carrying strap and securement device to prevent computer access by way of a windable spool of ruggedized cable that surrounds the outer shell of the computer to prevent opening of the laptop or access to the tablet screen by applying a compression fitting therearound. The internal mechanisms for securement of the fitting include a spool of cable, wire or reinforced strap material, a ratchet mechanism for drawing in the cable and applying compression to the computer, a ratcheting and carrying handle, a release mechanism, and accessories for charging the computer or securing it to an external structure via a cable tie.

Portable computer and tablet theft are a common occurrence in common areas or when such devices are left unaccompanied and unsecured. Physical security and locking mechanisms are necessary to prevent unauthorized access to the computer and further to prevent another individual from stealing the computer from its user. The costs associated with such theft go beyond the value of the computer hardware, and extend to the contents of the computer and the time spent personalizing the device for its user's preferences or intentions. It is common for individuals to store vast amounts of personal data and business-related data on personal computers, which makes their theft far more damaging than the replacement cost of the computer hardware. Personally identifying information, personal documents and photographs, business-related data and transactional information, along with personal preferences and programs are all commonly stored on computers. The loss of such data can be devastating emotionally and financially, as well as expose the owner to the risk of allowing personal information of others and himself or herself into the open for others to gather and use for unintended purposes.

Traditional means of physically locking a portable computer include cable tie locks that affix to the chassis of the computer and are adapted to wrap around an external structure. These devices are useful for securing the computer for extended periods in a single location, but offer little in the way of security while transporting the computer. Popular travel security means include lockable computer cases and travel bags. These devices are generally suited for carrying laptop computers or tablets within a larger briefcase or suitcase device that has a lockable zip closure or similar security closure means. Computer travel bags can be bulky and less than convenient when trying to access the computer while on the go, particularly in crowded areas, while entering an airport or when attempting to quickly access the computer while traveling.

More convenient computer travel devices are available in the form of carrying straps that are adapted to surround the exterior of the laptop or table computer and provide a carrying handle. These devices are useful for providing a user with a convenient carrying handle attachable to the computer such that the user can transport the device with one hand and allow quick and convenient deployment thereof. These devices, however, offer almost no security for the computer and no means of preventing theft thereof. These devices are more adapted for convenience than security, and therefore expose the computer to the threat of theft, tampering or unauthorized access when transporting the computer away from the user's home or business.

The present invention is therefore provided to improve both convenience and ease of access to a computer while in transit, while also providing a device that provides physical securement of the computer such that access is limited to authorized users and instances of theft are reduced and deterred. Specifically, the present invention relates to an elongated carrying band adapted to secure over a closed laptop or tablet computer, wherein the band includes a carrying handle. The carrying handle doubles as a ratcheting means for cinching an internal security wire that runs the length of the band and is drawn into a spool so as to reduce the length of the band and placed compression on the outer structure of the computer. This prevents computer from being opened or otherwise accessed, and prevents the band from readily being slid from off of the computer. The band and internal ratchet means create a compression fitting that secures the computer, while also providing a convenient carrying device for on-the-go handling of the computer and promoting ease of access to authorized users. The ratcheting handle includes a cable release mechanism and a locking mechanism for releasing or maintaining the compression on the computer while installed therearound.

2. Description of the Prior Art

Devices have been patented and disclosed in the prior art that relate to computer locking systems and carrying devices. These include patents and published patent applications for computer cases, computer briefcases and covers that are adapted to surround a portable computer and prevent unauthorized access. While these devices may be suited for their particular assignments, they are generally either too bulky or cumbersome, provide little security, or alternatively do not lend themselves to ease of access to the computer. The devices deemed most relevant to the present invention are herein discussed for the purposes of noting their key differences in structure and intent, along with their inherent drawbacks as it relates handling and security of a portable computer or tablet device.

Specifically, U.S. Pat. No. 5,682,993 to Song discloses a computer cover for transporting and protecting a portable computer, comprising a closable upper and lower rectangular tray joined by a zipper. The cover allows the computer to be operated while being partially enclosed by the trays, while allowing connection to nearby peripheral devices via apertures through the trays. Lower struts are further attachable to the lower tray to angle the computer keyboard for improved ergonomics during use. While discloses a portable computer cover, the Song device is more related to an enveloping cover that is zip closable rather than one that is adapted to lock the computer in a closed and locked position that prevents unauthorized access and sustained closure thereof. The present invention relates to a carrying case and locking mechanism that establishes a lockable compression fitting about the exterior of a laptop computer.

U.S. Pat. No. 5,871,094 to Leibowitz is another device that discloses a laptop computer case and stand comprising a base having a compartment for storing a laptop computer therein, wherein the device provides a securing case and a stand for elevating the computer keyboard while in an open position. When in a stowed position, the device operates as a carrying case that encloses the laptop computer. A lid is hinged at the base of the device, wherein the lid provides a cover over the laptop and is hingeable to open when the laptop screen is placed in an open position. Similar to the Song disclosure, the Leibowitz device provides an exterior-enveloping case that operates as a convertible carrying case and computer stand. The present invention, alternatively, is an encircling compression fitting that operates as a carrying case and a security device, whereby the device is compressed about the exterior of the laptop to prevent opening or sliding of the device from the laptop once engaged.

U.S. Pat. No. 6,871,739 to Lopez discloses a carrying case for a portable computer that comprises an open state to allow operation of the computer, and a closed state for protection therearound. The case comprises a closely-sized enclosure having six faces and internal padding for shock protection of the computer. The six faces include a top and bottom surface, along with four edge surfaces that come together to form an outer enclosure around the computer. The Lopez device provides a carrying case that is similar to a box construction, whereby panels are joined to form the case and are openable to allow operation of the computer. The present invention provides a more convenient and smaller-scale device that encircles the exterior of the computer in a strap-cover configuration. Within the encircling cover are a plurality of tightenable cables and windable, lockable spool that create a compression fitting about a closed laptop. The device functions as a carrying strap, security device and accessory device that reduces instances of computer theft and access, while providing convenient features for the purposes of carrying or charging the laptop.

Similar to the aforementioned prior art devices, U.S. Published Patent Application Publication No. 2008/0251339 to Williams discloses a laptop computer carrier case comprising an elongated strap that is generally loop-shaped that is adapted to extend about the exterior of a laptop computer and secure thereto via surface fastening means. The loop-shape is adapted to wrap around the exterior of a closed laptop and support the hinge end and sides thereof, while interior fastening means may be employed to secure to the outer surface of the computer. The exterior of the strap may also include fastening material to attach accessory pockets and holders for other articles, including books, pens and notepads. The Williams device comprises a strap material that is adapted to surround and support a laptop computer such that a user can carry the laptop with one hand, transforming the laptop and strap into a briefcase style assembly. No laptop security or locking means is provided, but rather a loosely fitted or exteriorly attached carrying strap is disclosed.

Finally, U.S. Pat. No. 7,455,339 to Staples describes an apparatus for carrying a laptop computer, comprising an elongated strip for wrapping around a laptop computer, the strip having a length, width and an open ended construction secured via hook and loop fasteners to form an enclosed loop structure. A handle member having a slotted portion engages the strip for creating a strap having an attached handle that allows a user to carry a laptop computer in one hand for improved transport thereof. The device incorporates no locking means that would prevent theft or unauthorized access to the computer, but rather the device is adapted for providing an inexpensive and simple handled strap device for hand-carrying a laptop computer.

The present invention provides a new and improved carrying strap device for a portable computer, and one that incorporates several security features to prevent theft and unauthorized access. These include mechanisms within the band to affect a lockable compression fitting about the computer, as well as a cable tie connection for securing the assembly about an external structure for prolonged, unaccompanied periods. Along with security features, the band includes several convenience features or accessories for the user, including a means to charge the computer while attached, and finally a display screen for showing the time of day, temperature or other data of interest thereon. The structure, intent and design of the present invention substantially diverges in elements from the prior art, and consequently it is clear that there is a need in the art for an improvement to existing security and convenience portable computer carrying devices. In this regard the instant invention substantially fulfills these needs.

### SUMMARY OF THE INVENTION

In view of the foregoing disadvantages inherent in the known types of portable computer carrying devices now present in the prior art, the present invention provides a new security and convenience carrier wherein the same can be utilized for providing convenience for the user when carrying or security a portable laptop or tablet computer.

It is therefore an object of the present invention to provide a new and improved portable computer carrying and security device that has all of the advantages of the prior art and none of the disadvantages.

It is another object of the present invention to provide a portable computer carrying device that offers superior security while traveling with a portable computer, wherein an internal cable system and ratcheting handle establish a compression fitting about the computer to prevent unauthorized access or opening thereof.

Another object of the present invention is to provide a portable computer carrying device that offers superior security while offering improved ease of access to the computer for authorized users, wherein access is available upon releasing the band and opening the computer. This means of access is less bulky and cumbersome than that provided by larger carrying cases or briefcase-style computer cases.

Yet another object of the present invention is to provide a portable computer carrying device that prevents unauthorized access to the computer, while also providing a means to secure the assembly to a secondary structure via a cable tie connection, preventing and deterring theft.

Another object of the present invention is to provide a portable computer carrying device that offers convenience features for the user while the band is attached, including a solar array for charging the computer and a digital display for providing information to the user.

Still yet another object of the present invention is to provide a locking band device that is capable of adapting its length to conform to the exterior of a portable computer based on the cinching motion of the ratchet mechanism and the shortening of the internal cable length as it is drawn into the ratchet spool.

A final object of the present invention is to provide a portable computer carrying, locking and convenience device that offers protection and convenience with varying levels of sophistication and accessory, wherein the device may be provided in varying combinations of accessories or protection levels to suit a particular user.

Other objects, features and advantages of the present invention will become apparent from the following detailed description taken in conjunction with the accompanying drawings.

BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

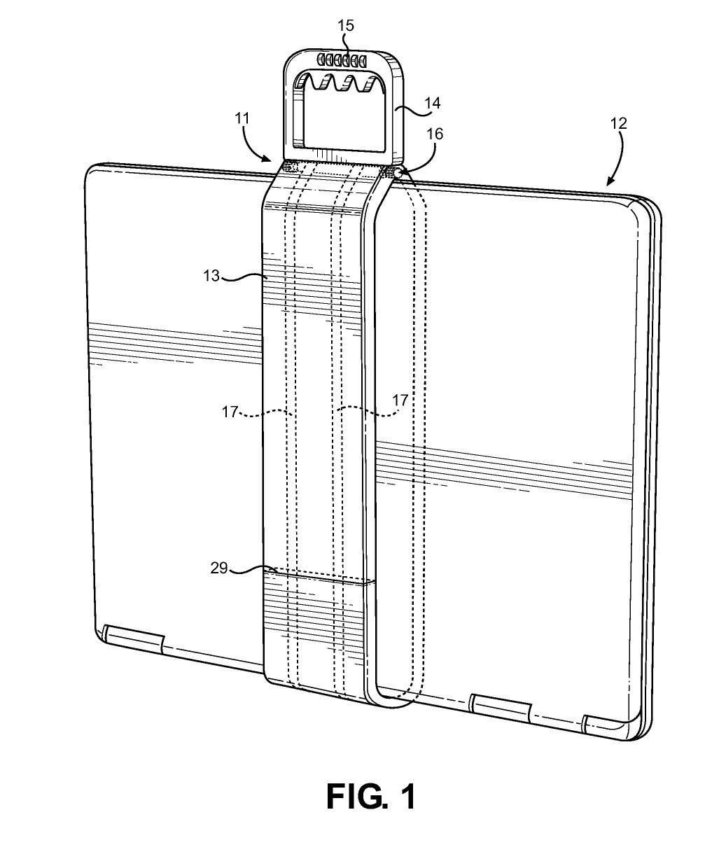

FIG. 1 shows a perspective view of the present invention in a working state, secured about a laptop computer.

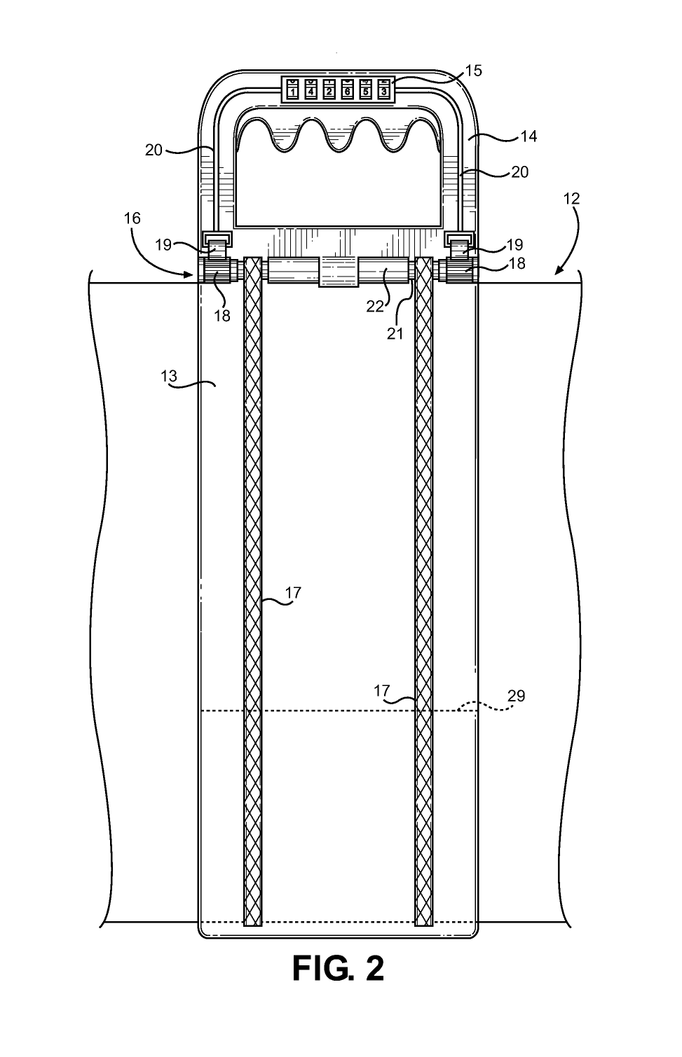

FIG. 2 shows a front view of the present invention in a working state, wherein the internal locking and ratcheting mechanisms are visualized.

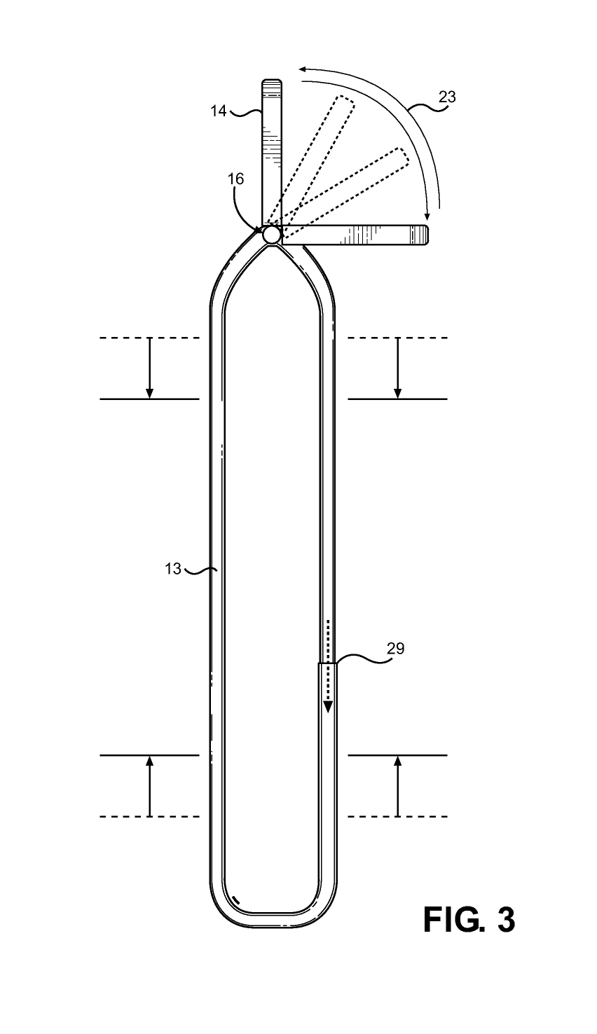

FIG. 3 shows a side view of the present invention, wherein the ratcheting action of the handle and the shortening of the band to affect a compression fitting are visualized.

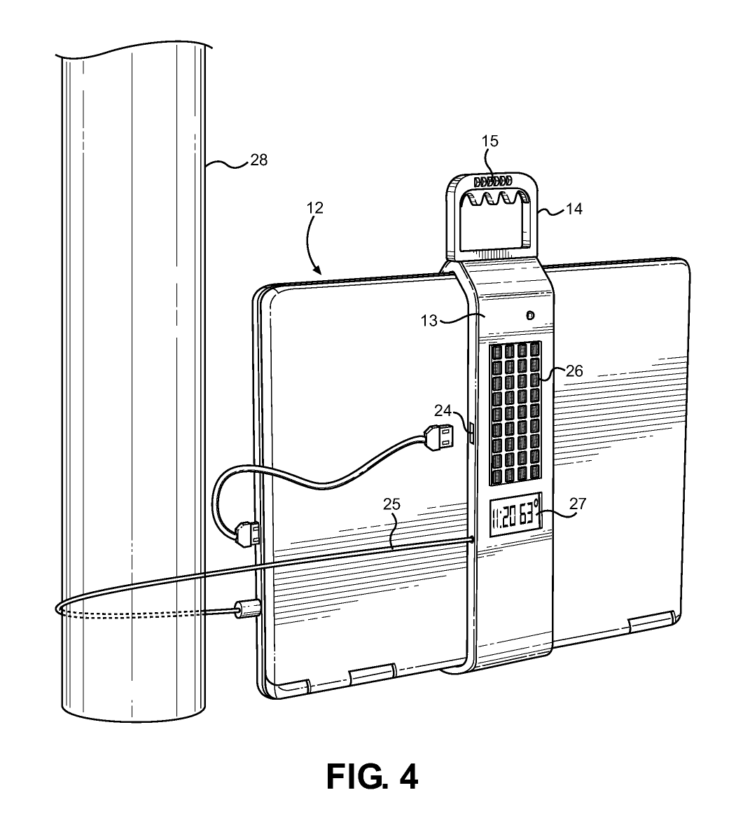

FIG. 4 shows a perspective view of the device in a working state being secured about a larger structure to prevent theft.

### DETAILED DESCRIPTION OF THE INVENTION

Reference is made herein to the attached drawings. Like reference numerals are used throughout the drawings to depict like or similar elements of the portable computer carrying and security device. For the purposes of presenting a brief and clear description of the present invention, the preferred embodiment will be discussed as used for providing a lockable carrying and convenience device for a portable computer. The figures are intended for representative purposes only and should not be considered to be limiting in any respect.

Referring now to FIG. 1, there is shown a perspective view of the present invention 11 in a working state and secured about the outer surface of a closed laptop computer 12. The present invention comprises an elongated strap 13 forming a continuous loop having an interior space adapted to fit a portable laptop or tablet computer and an internally enclosed volume within the strap to house the locking features of the present invention. Attached to the strap 13 is a carrying and ratcheting handle 14 that provides a user hand carrying grip and a means for cinching the locking features of the strap about the computer 12 to affect a secure fitting therearound. The locking features within the strap 13 comprise at least one, and preferably a pair of internal cables 17 that are routed within the strap interior and along its length. The cables 17 are affixed and wound about a rotating spool and ratcheting mechanism 16 that draws the cable onto the spool and shortens its length for the purpose of tightening the strap 13 about the exterior of the computer 12. This makes the strap act as a compression fitting that is compresses the exterior of the computer to prevent unauthorized access or opening of the computer, and further prevents the strap 13 from being slipped off of one end of the computer to circumvent its securement. The handle 14 is connected to the spool 16 and acts as the ratcheting means and means to release the ratchet, and thus the tension through the cables 17 and further release the compression on the exterior of the computer. The release mechanism within the handle 14 is lockable via a combination 15 or key lock that allows only authorized users to release the ratchet mechanism.

Once the computer, be it a laptop computer or tablet device, is fitted within the loop created by the elongated strap 13, the loop circumference is reduced by the internal cables 17, which shortens the strap 13 length and thus applies an exterior compression on the computer device to prevent access to the computer and removal of the strap therefrom. In use, it has been shown that on a few pounds per square inch of pressure is required to prevent the strap 13 from being capable of sliding from the laptop exterior. At the same time, this pressure is not sufficient enough to damage the structure of the laptop or tablet once installed. In one embodiment, the strap loop interior surface comprises of a higher friction material than that of the exterior strap surface, wherein sliding of the device along the computer is further prevented. Laptop computers generally incorporate a lid or closable screen, which is prevented from opening when the present device is installed. Tablet computers generally employ an outwardly facing screen that is accessible via an external button or slide motion along the screen. Portable computer of both type are afforded protection via the present invention, wherein locking of a laptop is achieved by preventing the screen from opening, while the screen of the tablet is sufficiently covered to prevent unlocking of the screen while the device is secured thereover. This broadens the applicability of the present locking, handling and convenience strap to a large range of computer styles. Further, the size of the strap may be tailored to accommodate larger or smaller computer types, which allows the computer to first be fed into the strap loop, and further allows the loop to adequately compress the computer within minimal change in strap length.

The strap covering 13 of the present invention may comprise a continuous length of material having an interior volume that houses the cinching cables 17 and the mechanisms 16 for securing the assembly. In this embodiment, the covering 13 is compressed against the exterior of the laptop, and the material of the covering shrinks to a size conforming to the exterior of the attached computer 12. While this has shown to be an effective covering, it is preferred that the strap covering 13 comprise at least two segments, wherein the segments of the covering 13 are adapted to telescope into one another at a junction 29. As the cables 17 are tightened and the computer 12 is compressed, the segments of the covering 13 condense into one another to form a shorter overall length, preventing any bunching or wrinkling of the covering material, but rather allowing one segment to telescope into the interior of a second segment. To accomplish this, a portion of one segment may be attached to the cables 17, whereby cinching movement of the cables draws the coverings therewith and into a second segment, collapsing the length into a shorter run.

Referring now to FIG. 2, there is shown a frontal view of the ratcheting mechanisms and cable system within the internal cavity of the present invention. Within the elongated strap 13, at least one cable 17 is provided along the strap 13 length and along its closed loop, terminating at a ratcheting spool mechanism 16. The mechanism 16 comprises a cylindrical spool 22 having cable winding locations 21, at least one splined ratchet wheel 18, a ratchet driving pawl 19 connecting to a release mechanism. The spool 22 connects to the handle 14 such that rotation of the handle 14 affects a rotation of the spool, drawing in the cables 17 onto the spool 21 and thus shortening the extended cable 17 length. As the spool 22 is rotated, the splines of the ratchet wheel 18 advance and the pawl secures its position by engaging each successive spline to prevent reverse rotation. This mechanism is well known in the art and would be readily recognizable to one skilled in the art of ratchet and rotational drive mechanisms.

As the cables 17 are wound around the spool 21, their length decreases and tension builds within the cables as they compress the computer 12 within the strap 13 loop. The cables 17 can be drawn into the spool 21 to establish sufficient compression on the computer 12 such that the screen cannot be accessed and the strap 13 cannot be slide along the exterior of the computer 12. This prevents access to the computer and prevents the device from being slid off of the computer exterior. The strap 13 therefore becomes a compression fitting about the computer, wherein compression is controlled by the ratcheting mechanism and the unwound length of cable 17. In the preferred embodiment, the strap coverings 13 condense into a smaller length, whereby the covering is segmented and the segments are adapted to telescope into one another 29. A release mechanism within the handle 14 allows the spool to be unwound to release the wound cable 17. The release mechanism is engaged by pulling the handle 14 away from the spool 22 to release the ratchet pawl 19 and allow the cables 17 to be unwound. This releases compression on the computer and thus allows the strap to be disengaged for access to the computer. The release mechanism is governed by a lock 15, which comprises a combination lock or key lock that prevents outward motion of the handle 14 and thus release of the ratchet pawl. In one embodiment, the release mechanism is a handle that is slideable away from the spool 22 and connected to the ratchet pawl 19. A release cable 20 and the lock 15 controls the sliding of the handle such that release of the ratchet pawl is capable only when the correct combination or key is input into the lock 15.

Several mechanical embodiments of the locking and cinching mechanism are contemplated, and it is not desired to limit this locking and ratcheting handle mechanism to a single design, but rather it is desired to disclose a combination of elements that affect a locking and ratcheting spool operated by the handle 14. In a more advanced embodiment of the present invention, the mechanical cinching mechanisms of the spool are replaced with an electric motor and motor controller, whereby activation of the motor rotates the spool in a desired direction to wind or unwind the cables 17. The controls for this embodiment may be on the along the strap 13 itself or built into the handle 14, wherein the handle is no longer a ratchet means, but rather a user handle for supporting the device and attached computer.

Referring now to FIG. 3, there is shown a side view of the present invention, wherein the ratcheting motion of the handle 15 and the compression of the strap 13 are visualized. Once a computer is placed within the strap 13 interior loop, the strap is tightened onto the compute exterior via the aforementioned ratcheting mechanism 16. The handle 14 attaches to the ratcheting mechanism 16, whereby the handle 14 is rotated 23 back and forth to draw the strap cables inward, reducing the perimeter length of the strap length and generating compression on the computer. The strap can be tightened to generate sufficient compression the compute such that the screen is inaccessible and the strap is not readily removable from or slideable along the computer exterior surface.

Accompanying the internal locking and securement mechanisms within the strap, the present invention further provides several exterior locking and convenience features. These include a means for securing the strap and attached computer to a larger structure, a means for charging the secured computer and a display screen for communicating information to the user while deployed. Referring to FIG. 4, there is shown a view of the present invention in a working state, including several exterior locking and convenience features, along with a view of the assembly being secured to a larger structure. Along with the ability to secure a computer closed and unusable, an external cable lock 25 attachable to the strap 13 allows the assembly to be secured to a larger structure 28 to prevent theft of the computer 12 and strap 13 when left unaccompanied. The cable lock 25 securely affixes to the strap 13 for support on a first end, and on a second end attaches to the laptop's cable lock securement location along the computer chassis. This allows the assembly to be affixed to a desk, pole or similar larger structure when left unaccompanied for periods of time.

Further provided along the strap 13 may be several convenience features for the user. The first of these include a photovoltaic array 26 for creating electrical energy from light, along with a power cord connection 24 for transferring electrical energy from the array 26 and its circuitry directly to the computer battery pack. This option requires a cable that matches the specific computer AC power cord connector and the appropriate connector for the present invention. This allows the battery of the computer to be slowly recharged while stowed in the strap 13, without the need to be plugged into a wall outlet for power. In an alternate embodiment, the photovoltaic array assembly further comprises battery storage for storing electrical power for later use by the attached computer. Further provided may be a display screen 27 along the exterior of the strap 13, which can be programmed to display information to the user, including the local time, temperature or identifying information about the owner of the computer. Further still, the strap may also provide physical storage of article via a pocket or plurality thereof, and finally an externally-directed illumination means for lighting a workspace or pathway while walking with the device.

Within the strap may further be a GPS transponder for locating the device, which may provide a user with the location of his or her computer if the assembly was not cable locked to a secure structure and stolen or misplaced. These options expand the security and carrying features of the present invention by adding convenience options that are optionally available. Further embodiments of the strap 13 contemplate exterior pockets and accessories common to computer carrying cases and strap devices, including colors, patterns and accessory attachments. A further embodiment of the cable lock 25 attachment comprises an audible tampering alarm, which is adapted to activate if the device registers excessive tension in the cable lock 25 such that it is determined that an unauthorized user is attempting to tamper with the cable lock or the strap. In this embodiment, tension is monitored in the cable lock 25 at its attachment location within the strap 13. When the cable lock is extended and in use, excessive tension in the cable lock 25 activates an audible alarm, which notifies those around the computer that the computer and security device is being tampered. The goal is to ward off would-be thieves attempting to steal a secured computer while attached to a structure via the cable lock 25.

Many individuals frequently use their laptops for work, studying, and for documenting sensitive and confidential information. If laptops are left unattended, even for a few moments, they may be stolen or accessed by unauthorized individuals. This breach of security may result in confidential information being passed to unauthorized individuals, which can be highly problematic, costly and dangerous. Additionally, traveling with laptops can be difficult, as laptops may be difficult to carry and may require frequent recharging sessions. The present invention provides a unique carrying device that offers a lightweight, easily managed and easily operated carrying strap that allows computer carrying with a single hand and access thereto without cumbersome steps or removing the computer from a larger briefcase-style carrying case. The imbedded security features allow the computer to remain unusable to unauthorized individuals, and further securable to a static structure for deterring and preventing theft of the computer. Finally, the convenience of the device design and its accessories provide users with a means of readily accessing the computer and utilizing its convenience features.

Overall, the present invention provides users with a lockable carrying and convenience device for portable computers and tablet devices. The design of the strap and its compression fitting is an effective way to keep laptops secure and protected from unwanted intrusions, while minimizing its bulk size and its weight. Using this product allows consumers to secure, easily transport and carry, track, re-charge, and lock laptops so they cannot be opened by intruders. In light of the present disclosure and the aforementioned prior art, it is submitted that the present invention has been shown and described in what is considered to be the most practical and preferred embodiments and is sufficiently divergent from existing devices. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A portable computer locking and carrying device, comprising:
an elongated strap forming a closed loop and having an enclosed internal volume;
at least one locking cable within said internal volume and running along said strap length;
said at least one cable attached to a rotatable spool, said spool adapted to wind said cable therearound;
said spool adapted to draw in said cable and reduce said closed loop perimeter, creating a compression fitting for securing an object within said closed loop;
a release means for releasing said spool to unwind said cable;
a means of affecting said spool rotation, a release means and a handle for carrying said strap;
a locking means that prevents said release means from freeing said spool.

2. The device of claim 1, wherein:
said spool is attached to a ratcheting mechanism;
said handle is affixed to said spool for rotating said spool and said ratcheting mechanism;
said locking means positioned within said handle for preventing release of said ratchet means and unwinding of said spool.

3. The device of claim 2, wherein said ratchet mechanism is a splined ratchet wheel on said spool and a ratchet pawl for preventing said spool from unwinding.

4. The device of claim 2, wherein said locking mechanism is a combination lock that prevents said release mechanism from freeing said ratchet mechanism and said spool.

5. The device of claim 2, wherein said locking mechanism is a key lock that prevents said release mechanism from freeing said ratchet mechanism and said spool.

6. The device of claim 2, wherein pulling said handle operates said release mechanism when said locking mechanism is disengaged.

7. The device of claim 1, wherein:
said spool is attached to an electric motor for rotating said spool and winding said cable around said spool;
said release means being adapted for reversing electric motor and said spool rotation to unwind said cable;
said locking means for controlling operation of said electric motor and release means.

8. The device of claim 1, wherein said closed loop is adapted to fit a portable computer therein.

9. The device of claim 1, wherein said strap further comprises a cable lock having a first end that affixes within said strap and a second end that is adapted to be attached to a computer chassis.

10. The device of claim 1, wherein said cable lock first end further comprises a tension monitor and alarm for notifying when a tamper situation occurs.

11. The device of claim 1, wherein said strap further comprises a photovoltaic array assembly for creating electricity, an electrical outlet from said assembly and along said strap, and a cable adapted to connect from said outlet to a computer within said strap loop for charging said computer battery.

12. The device of claim 11, wherein said photovoltaic array assembly further comprises an energy storage battery for storing power for use by said computer.

13. The device of claim 1, wherein said strap further comprises a display screen and programmable memory for communicating programmed information.

14. The device of claim 1, wherein said strap further comprises an internal global positioning transponder for locating said strap.

15. The device of claim 1, wherein said elongated strap comprises at least two segments, wherein said segments are adapted to telescope into one another as said cable is drawn and said strap loop perimeter is reduced.

16. The device of claim 1, wherein said elongated strap further comprises an inner loop surface having a high friction material that resists sliding along a secured object within said closed loop.

17. The device of claim 1, wherein said strap further comprises a light source for illuminating a work surface or pathway.

18. The device of claim 1, wherein said strap further comprises an external pocket for storing personal articles.
